(19) United States
(12) Patent Application Publication
(10) Pub. No.: US 2024/0186623 A1
(43) Pub. Date: Jun. 6, 2024

(54) PACKAGING MATERIAL FOR ALL-SOLID-STATE BATTERIES AND ALL-SOLID-STATE BATTERY

(71) Applicant: Resonac Packaging Corporation, Hikone-shi (JP)

(72) Inventors: Terutoshi KUMAKI, Hikone-shi (JP); Daisuke NAKAJIMA, Hikone-shi (JP)

(73) Assignee: Resonac Packaging Corporation, Hikone-shi (JP)

(21) Appl. No.: 18/443,284

(22) Filed: Feb. 15, 2024

Related U.S. Application Data
(63) Continuation of application No. PCT/JP2022/030550, filed on Aug. 10, 2022.

(30) Foreign Application Priority Data
Aug. 16, 2021 (JP) 2021-132360

(51) Int. Cl. H01M 50/141; H01M 10/653; H01M 50/119; H01M 50/124; H01M 50/126; H01M 50/131

(52) U.S. Cl. CPC H01M 50/141; H01M 10/653; H01M 50/119; H01M 50/1243; H01M 50/126; H01M 50/131

(57) ABSTRACT

A packaging material for all-solid-state batteries for encapsulating a solid-state battery body, includes a substrate layer, a metal foil layer laminated on an inner surface side of the substrate layer, a sealant layer laminated on an inner surface side of the metal foil layer, and a heat-resistant gas barrier layer made of resin, the heat-resistant gas barrier layer being provided between the metal foil layer and the sealant layer. The sealant layer is provided with an opening portion formed in a portion corresponding to the solid-state battery body to be encapsulated. The heat-resistant gas barrier layer is exposed on an inner side in the opening portion.

### CROSS-REFERENCE TO RELATED APPLICATIONS

The present application is a continuation application of International Application No. PCT/JP2022/030550, filed on Aug. 10, 2022, which claims priority to Japanese Patent Application No. 2021-132360, filed on Aug. 16, 2021, the contents of which are incorporated herein by reference in its entirety.

### BACKGROUND OF THE INVENTION

### Technical Field

The present disclosure relates to a packaging material for all-solid-state batteries and an all-solid-state battery. More specifically, the present disclosure relates to a packaging material for all-solid-state batteries and an all-solid-state battery suitable for use as, but not limited to, a high-power battery for automotive batteries, a battery for portable devices such as mobile electronic devices, a battery for storing regenerative energy, and the like.

### Description of the Related Art

The following description sets forth the inventor's knowledge of related art and problems therein and should not be construed as an admission of knowledge in the prior art.

A lithium-ion secondary battery, which is commonly used in conventional applications, utilizes a liquid electrolyte as an electrolyte. Therefore, there were risks of separator breakage due to liquid leakage or dendrite formation and, in some cases, ignition due to short-circuiting.

In contrast, an all-solid-state battery utilizes a solid-state electrolyte, so it does not cause electrolyte leakage or dendrite formation, and therefore, no separator breakage will occur. Therefore, there is no concern about ignition or the like due to separator breakage, which is attracting a great deal of attention from a safety standpoint.

A regular all-solid-state battery is configured by encapsulating a solid-state battery body composed of, e.g., an electrode active material and a solid electrolyte, with packaging materials as a casing. As research on solid-state batteries advances, the performance requirements for packaging materials for use in all-solid-state batteries have gradually become different from those for conventional batteries using liquid electrolytes. Various packaging materials have been proposed to meet the performance requirements for all-solid-state batteries.

The basic structure of a packaging material for all-solid-state batteries includes a metal foil layer and a heat-fusible layer (sealant layer) laminated inside the metal foil layer, and the sealant layers are heat-sealed to encapsulate a solid-state battery body.

For example, the packaging material for all-solid-state batteries shown in Patent Document 1 has a protective layer interposed between a metal foil layer and a sealant layer, and a layer high in hydrogen sulfide gas permeability is used as the sealant layer. Further, the packaging material for all-solid-state batteries described in Patent Document 2 uses a layer high in hydrogen sulfide gas permeability as a sealant layer. Further, the packaging material for all-solid-state batteries described in Patent Document 3 utilizes a gas-absorbing sealant layer. Further, the packaging material for all-solid-state batteries described in Patent Document 4 is configured such that a vapor-deposited film layer is laminated on the inner surface of the sealant layer.

### PRIOR ART DOCUMENT

### Patent Document

Patent Document 1: Japanese Patent No. 6777276
Patent Document 2: Japanese Patent No. 6747636
Patent Document 3: Japanese Unexamined Patent Application Publication No. 2020-187855
Patent Document 4: Japanese Unexamined Patent Application Publication No. 2020-187835.

However, the above-described conventional all-solid-state batteries have a problem that a gas, such as, e.g., a hydrogen sulfide gas produced by the reaction between the solid electrolyte and moisture, may leak out.

On the other hand, all solid-state batteries cause exchanges of electrons (ions) by the solid electrolyte during the charging and discharging, resulting in higher resistance and greater heat generation as compared with liquid electrolytes. However, it is considered that the performance of an all-solid-state battery itself is not affected even in a high-temperature environment, and there has been no consideration of high-temperature countermeasures (cooling performance) in prior arts including Patent Documents 1 to 4 described above. However, as the battery technology advances toward higher output and higher capacity, it is well foreseeable that in the future, all-solid-state batteries will require improved cooling performances.

Some preferred embodiments of the present disclosure have been made in view of the above-described and/or other problems in the related art. Some preferred embodiments of the present disclosure can significantly improve existing methods and/or equipment.

### SUMMARY OF THE INVENTION

The present disclosure has been made in view of the above-described problems, and the purpose of the present disclosure is to provide a packaging material for all-solid-state batteries and an all-solid-state battery capable of ensuring sufficient cooling performance while preventing leakage of a sulfide gas, etc.

Other objects and advantages of the present disclosure will be apparent from the following preferred embodiments.

In order to solve the above problems, the present disclosure provides the following means.

A packaging material for all-solid-state batteries for encapsulating a solid-state battery body, comprising:
a substrate layer;
a metal foil layer laminated on an inner surface side of the substrate layer;
a sealant layer laminated on an inner surface side of the metal foil layer; and
a heat-resistant gas barrier layer made of resin, the heat-resistant gas barrier layer being provided between the metal foil layer and the sealant layer,
wherein the sealant layer is provided with an opening portion formed in a portion corresponding to the solid-state battery body to be encapsulated, and
wherein the heat-resistant gas barrier layer is exposed on an inner side in the opening portion.

### BRIEF DESCRIPTION OF THE DRAWINGS

Some embodiments of the present disclosure are shown by way of example, and not limitation, in the accompanying figures.

FIG. 1 is a schematic cross-sectional view showing an all-solid-state battery according to an embodiment of the present disclosure.

FIG. 2 is an exploded view schematically showing a configuration of an all-solid-state battery according to an embodiment.

### EMBODIMENTS FOR CARRYING OUT THE INVENTION

In the following paragraphs, some preferred embodiments of the present disclosure will be described by way of example and not limitation. It should be understood based on the present disclosure that various other modifications can be made by those skilled in the art based on these illustrated embodiments.

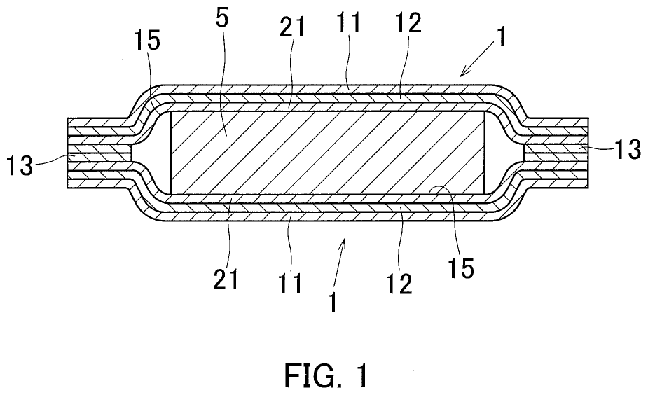

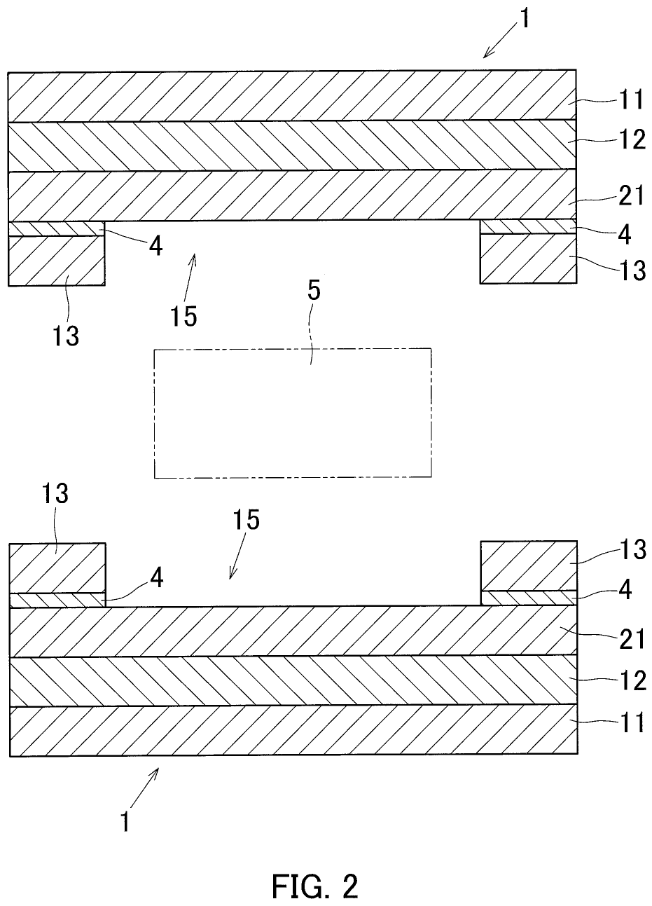

FIG. 1 is a schematic cross-sectional view showing an all-solid-state battery according to an embodiment of the present disclosure. FIG. 2 is an exploded view schematically showing the configuration of the all-solid-state battery. As shown in both the figures, the all-solid-state battery according to this embodiment is provided with a packaging materials 1 and 1, which are configured as the casing of an all-solid-state battery, and a solid-state battery body 5, which is to be accommodated and sealed with the packaging materials 1 and 1.

The packaging material 1 is provided with a substrate layer 11 arranged on the outermost side, a metal foil layer 12 laminated and bonded to the inner side of the substrate layer 11 via an adhesive layer, a heat-resistant gas barrier layer 21 laminated and bonded to the inner side of the metal foil layer 12 via an adhesive layer, and a sealant 13 laminated and bonded to the inner side of the heat-resistant gas barrier layer 21 via an adhesive layer 4. The sealant layer 13 has an opening portion 15 formed by removing the intermediate portion thereof except for its outer peripheral edge portion, and remains only at the outer peripheral portion. This packaging material 1 has no adhesive layer 4 at the opening portion 15, and the heat-resistant gas barrier layer 21 is positioned so as to be exposed on the inner side via the opening portion 15.

In this embodiment, two sheets of (a pair of) rectangular-shaped packaging materials 1 and 1 are overlaid one on top of the other with the sealant layers 13 of their outer peripheral portions facing each other via a solid-state battery body 5. The sealant layers 13 and 13 are heat-sealed in an airtight (sealed) manner. With this, an all-solid-state battery is produced in which the solid-state battery body 5 is accommodated in a sealed state in a bag-like casing composed of the packaging materials 1 and 1.

In this all-solid-state battery, the opening portion 15 of the packaging material 1 is arranged in the portion corresponding to the solid-state battery body 5. Thus, the upper and lower surfaces of the solid-state battery body 5 are arranged so as to face the heat-resistant gas barrier layers 21 of the upper and lower packaging materials 1 via the opening portions 15.

Further, in this all-solid-state battery according to this embodiment, tab leads are provided for electrical extraction, although not shown in the figure. The tab leads are arranged so that one ends (inner ends) thereof are connected to the solid-state battery body 5 and the middle portions are drawn through the outer peripheral edge portions (sealant layers 13) of the two packaging materials 1 and 1, and the other end portions (outer end portion) are drawn to the outside.

Note that in this embodiment, the casing is formed by bonding two sheets of planar packaging materials and 1 and 1 together, but not limited thereto. In the present disclosure, at least one of the two sheets of packaging materials may be formed into a tray shape in advance, and then the one of the tray-shaped packaging material may be bonded to the other tray-shaped or planar packaging material to form a casing.

Hereinafter, the detailed configuration of the packaging material 1 for all-solid-state batteries according to this embodiment will be described.

The substrate layer 11 of the packaging material 1 is constituted by a heat-resistant resin film of 5 μm to 50 μm in thickness. As the resin constituting this substrate layer 11, polyamide, polyester (PET, PBT, PEN), polyolefin (PE, PP), etc., can be suitably used.

The metal foil layer 12 is set to have a thickness of 5 μm to 120 μm and blocks the ingress of oxygen and moisture from the front surface (outer surface) side. As this metal foil layer 12, an aluminum foil, a SUS foil (stainless steel foil), a copper foil, a nickel foil, etc., can be suitably used. Note that the terms “aluminum,” “copper,” and “nickel” are used to include their alloys in this embodiment.

By subjecting the metal foil layer 12 to plating, etc., the risk of occurrence of pinholes is reduced, which can improve the function of blocking the ingress of oxygen and moisture even further.

Furthermore, by subjecting the metal foil layer 12 to a chemical conversion treatment, such as, e.g., a chromate treatment, the corrosion resistance further improves. This can more assuredly prevent the occurrence of defects, such as, e.g., chips, and can also improve bonding properties with resin, further enhancing durability.

The sealant layer 13 is designed to have a thickness of 10 μm to 100 μm and is composed of a heat-adhesive (heat-fusible) resin film. As the resin constituting this sealant layer 13, a group consisting of polyethylene (LLDPE, LDPE, HDPE), polyolefin such as polypropylene, olefin-based copolymers, their acid-modified products, and ionomers, such as non-stretched polypropylene (CPP, IPP), etc., can be suitably used.

For the sealant layer 13, it is preferable to use a polypropylene-based resin (non-stretched polypropylene film (CPP, IPP)), considering the use of tab leads to extract electricity, i.e., sealing and bonding properties with the tab leads.

Note that the details of the method of forming the opening portion 15 in the sealant layer 13 will be described later.

The heat-resistant gas barrier layer 21 is formed of a resin film having heat resistance and insulation properties. As the resin constituting this heat-resistant gas barrier layer 21, polyamide (6-nylon, 66-nylon, MXD nylon, etc.), polyethylene terephthalate (PET), polybutylene terephthalate (PBT), polyethylene naphthalate (PEN), cellophane, polyvinylidene chloride (PVDC), Stretched propylene (OPP), etc., are preferably used.

In this embodiment, it is preferable that the resin constituting the heat-resistant gas barrier layer 21 have a specified hydrogen sulfide (H₂S) gas permeability. Specifically, it is preferable that the heat-resistant gas barrier layer 21 be made of a resin having a hydrogen sulfide gas permeability of 15 {cc·mm/(m²·D·MPa)} or less, preferably 10 {cc·mm/(m²·D·MPa)} or less, more preferably 4.0 {cc·mm/(m²·D·MPa)} or less, at the measurement value as measured in accordance with JIS K7126-1.

In other words, in the case where the hydrogen sulfide gas permeability of the heat-resistant gas barrier layer 21 is set to a value equal to or less than the above-described specified value, the heat-resistant gas barrier layer 21 can prevent a hydrogen sulfide gas from leaking outside when the hydrogen sulfide gas is generated due to a reaction between the solid electrolyte material and moisture in the outside air. In other words, in the case where the hydrogen sulfide gas permeability of the heat-resistant gas barrier layer 21 is excessive, the generated hydrogen sulfide gas may leak out through the packaging material 1 (heat-resistant gas barrier layer 21) to the outside, which is undesirable.

Note that, for reference, the term “D” in the hydrogen sulfide gas permeability unit indicates “Day (24 h).

In this embodiment, the thickness (original thickness) of the heat-resistant gas barrier layer 21 is preferably set to 3 μm to 50 μm, more preferably 10 μm to 40 μm. In other words, in the case where the thickness of the heat-resistant gas barrier layer 21 is set within the above-described range, the permeation suppression function of the hydrogen sulfide gas and the water vapor gas described above can be achieved. Even if the sealant layer 13 melts and flows out due to thermal bonding, the heat-resistant gas barrier layer 21 can assuredly ensure the insulating properties. In other words, in the case where the heat-resistant gas barrier layer 21 is excessively thin, there is a risk that its gas permeation suppression function and insulating properties are not secured, which is not desirable. Conversely, in the case where the heat-resistant gas barrier layer 21 is excessively thick, it is not desirable because it not only makes it impossible to make the packaging material 1 thinner but also makes it impossible to fully achieve the effects by making the layer thicker than necessary.

In this embodiment, it is preferable to use a resin film as the heat-resistant gas barrier layer 21. In other words, the entire film becomes a barrier layer, so unlike a vapor-deposited film or the like, no barrier cracks occur, which can improve the barrier properties.

Further, as the resin film constituting the heat-resistant gas barrier layer 21, a non-stretched film or a slightly stretched film can be used, and a non-stretched film is especially preferred. In other words, in the case where a non-stretched film is used, the moldability and the gas barrier property can be further improved.

The heat-resistant gas barrier layer 21 of this embodiment is provided with good insulating properties, and even after encapsulating (sealing) the solid-state battery body 5 with the packaging material 1 of this embodiment by thermal bonding, good insulating properties are achieved.

In this embodiment, as the adhesive constituting the adhesive layer 4 adhering between the heat-resistant gas barrier layer 21 and the sealant layer 13, an adhesive of a two-part curing type, an energy ray (UV, X-ray, etc.) curing type, etc., can be used. Among them, a urethane-based adhesive, an olefin-based adhesive, an acrylic-based adhesive, an epoxy-based adhesive, etc., can be suitably used. Further, the thickness of the adhesive layer 4 is set to 2 μm to 5 μm.

Note that in this embodiment, as the adhesive that bonds between the substrate layer 11 and the metal foil layer 12 and between the metal foil layer 12 and the heat-resistant gas barrier layer 21, the same adhesive as that of the adhesive layer 4 described above can be suitably used, and the same thickness is preferably set.

As previously mentioned, the packaging material 1 of this embodiment has an opening portion 15 in the sealant layer 13. The opening portion 15 is formed in the portion corresponding to the solid-state battery body 5 to be encapsulated, and the sealant layer 13 is located at the portion corresponding to the heat-sealing portion (sealing portion).

In this embodiment, no inner adhesive layer 4 is provided in the opening portion 15 of the packaging material 1, and the heat-resistant gas barrier layer 21 is faced (exposed) on the inner side via the opening portion 15. In the state in which an all-solid-state battery is produced, the heat-resistant gas barrier layer 21 is positioned so as to face the solid-state battery body 5. In this embodiment, it is sufficient that at least a part of the solid-state battery body 5 is in contact with the heat-resistant gas barrier layer 21. Further, a part of the sealant layer 13 may be positioned corresponding to the solid-state battery body 5. For example, a part of the sealant layer 13 may be in contact with the solid-state battery body 5. However, it is possible to improve the heat dissipation when the solid-state battery body 5 is not in contact with the sealant layer 13.

In this embodiment, almost all areas of the top and bottom sides (both the inside and the outside) of the solid-state battery body 5 are preferably in contact with the heat-resistant gas barrier layers 21 and 21. In this case, the solid-state battery body 5 is held steady via the heat-resistant gas barrier layers 21, thereby preventing the displacement, etc., of the solid-state battery body 5.

Further, in this embodiment, no adhesive layer 4 is provided in the opening portion 15, but the present disclosure is not limited thereto. In the present disclosure, an adhesive layer 4 may be provided at least in part of the opening portion 15. However, the heat dissipation properties can be improved in the case where no adhesive layer 4 is provided as in this embodiment.

The opening portion 15 of the packaging material 1 in this embodiment is formed, for example, by cutting the intermediate portion of the sealant layer 13 that is laminated over the entire area of the heat-resistant gas barrier layer 21, while the sealant layer 13 on the outer peripheral edge portion remains.

That is, in this embodiment, when forming the sealant layer 13 on the heat-resistant gas barrier layer 21, an adhesive forming the adhesive layer 4 is coated on the inner surface of the resin film as the heat-resistant gas barrier layer 21 using a gravure roll, etc., and a resin film as the sealant layer 13 is adhered via the adhesive layer 4. When coating the adhesive on the heat-resistant gas barrier layer 21 with gravure rolls, etc., an adhesive unapplied portion with no adhesive is formed in the area where the opening portion is to be formed. Then, the resin film for the sealant layer is adhered to this heat-resistant gas barrier layer 21 with an adhesive uncoated area and dried. Thereafter, the resin film for the sealant layer in the adhesive uncoated area is cut off using a laser cutter, a roll blade, or the like, to form the opening portion 15 (first formation method).

A second formation method is as follows. Before coating an adhesive on the heat-resistant gas barrier layer 21, a release paper is temporarily attached to the area where the opening portion is to be formed on the heat-resistant gas barrier layer 21, and then an adhesive is coated on the heat-resistant gas barrier layer 21 with a gravure roll or the like, and the resin film for the sealant layer is adhered to the adhesive layer and dried. Thereafter, the resin film for the sealant layer in the adhesive uncoated area is cut off together with the adhesive and the release paper using a laser cutter, a roll blade, or the like, to form the opening portion 15 (second formation method). When using this second formation method, only the resin film for the sealant layer may be removed, or only the resin film for the sealant layer and the adhesive may be removed. In other words, the adhesive and the release paper may be made to remain, or only the adhesive may be made to remain.

As another formation method, it is conceivable to use a method (other formation method) in which a through-hole as the opening portion 15 is formed in a resin film for the sealant layer before bonding the resin film for the sealant layer to the heat-resistant gas barrier layer 21, and the resin film for the sealant layer with the opening portion is bonded to the heat-resistant gas barrier layer 21 via an adhesive. However, in this method, it is difficult to apply the adhesive evenly, and it is difficult to adhere the resin film for the sealant layer with an opening portion accurately and precisely. Therefore, it is preferable to employ the first or second formation method described above in this embodiment.

As described above, according to the all-solid-state battery of this embodiment, the heat-resistant gas barrier layer 21 is formed between the metal foil layer 12 and the sealant layer 13 in the packaging material 1, and the opening portion 15 through which the heat-resistant gas barrier layer 21 is exposed is formed in the portion of the sealant layer 13 corresponding to the solid-state battery body 5. Therefore, the heat generated from the solid-state battery body 5 is not blocked by the sealant layer 13 but is transferred to the metal foil layer 12 via the heat-resistant gas barrier layer 21 to dissipate the heat. Therefore, sufficient cooling can be assured, and defects due to high temperatures can be reliably prevented.

Here, in this embodiment, it is preferable to adopt a resin constituting the heat-resistant gas barrier layer 21 with a thermal conductivity of 0.2 W/m-K or higher. In other words, in the case of adopting this configuration, the heat-resistant gas barrier layer 21 can ensure a sufficient heat transfer property, which further improves the cooling property of the solid-state battery body 5.

In this embodiment, the heat-resistant gas barrier layer 21 is placed on the inner surface side of the metal foil layer 12. Therefore, even if a hydrogen sulfide gas or another gas is generated when the solid electrolyte of the solid-state battery body 5 reacts with moisture in the ambient air, the heat-resistant gas barrier layer 21 can assuredly prevent the leakage of such a gas. Further, the gas permeation prevention action of the heat-resistant gas barrier layer 21 prevents the ingress of moisture, such as water vapor gas, from the outside. Therefore, the generation of a hydrogen sulfide gas itself due to the reaction between the moisture and the solid electrolyte can also be suppressed, thereby more reliably preventing the leakage of a hydrogen sulfide gas or the like.

Here, in this embodiment, as the resin constituting the heat-resistant gas barrier layer 21, it is preferable to adopt a resin with a water vapor transmission rate of 50 (g/m²/day) or less, as measured in accordance with JIS K7129-1 (humidity sensor method, 40° C., 90% Rh). In other words, when this configuration is adopted, the heat-resistant gas barrier layer 21 can more assuredly prevent the ingress of moisture, which in turn can more assuredly prevent the generation and leakage of a hydrogen sulfide gas.

Further, in the all-solid-state battery of this embodiment, although no sealant layer 13 exists between the solid-state battery body 5 and the metal foil layer 12, the heat-resistant gas barrier layer 21 with an insulating property is placed between them, so that the insulating property can be assuredly secured by the heat-resistant gas barrier layer 21.

Further, in this embodiment, as the resin constituting the heat-resistant gas barrier layer 21, it is required to use a resin whose melting point is higher than that of the resin constituting the sealant layer 13 by 10° C. or more. In other words, when the heat-resistant gas barrier layer 21 has a high melting point, even if the sealant layer 13 is melted when thermally bonding the packaging material 1, it is possible to more assuredly prevent the melting out of the heat-resistant gas barrier layer 21. Therefore, the heat-resistant gas barrier property and the insulating property of the heat-resistant gas barrier layer 21 can be secured more assuredly.

Further, in the all-solid-state battery of this embodiment, the sealant layer 13 is not formed in the portion of the packaging material 1 corresponding to the solid-state battery body 5. Therefore, the space to accommodate the solid-state battery body 5 can be made larger (thicker). Therefore, as compared with conventional all-solid-state batteries, the all-solid-state battery of this embodiment can accommodate a larger size solid-state battery body 5 without changing the external dimensions of the casing (packaging material 1). Therefore, the all-solid-state battery of this embodiment can achieve higher output and capacity while thinning.

### Example

TABLE 1

| | Heat-resistant gas barrier layer | | | | | | |
|---|---|---|---|---|---|---|---|
| | | | | | water vapor | | |
| | | Layer | Thermal | | transmission | | |
| | | thickness | conductivity | H₂S permeability | rate | Opening | Cooling effect |
| | Material | (μm) | (W/m · K) | cc · mm/(m² · D · Mpa) | g/(m² · D) | portion | (° C.) |
| Ex. 1 | PET | 9 | 0.23 | 5.5 | 29 | Present | 80 ⇒ 33 |
| Ex. 2 | ONY | 9 | 0.18 | 1.4 | 270 | Present | 80 ⇒ 38 |
| Ex. 3 | OPP | 9 | 0.24 | 35 | 10 | Present | 80 ⇒ 32 |
| Ex. 4 | PVDC | 10 | 0.21 | 2.9 | 2.0 | Present | 80 ⇒ 35 |
| Ex. 5 | PVDC | 15 | 0.21 | 1.7 | 1.2 | Present | 80 ⇒ 36 |
| Ex. 6 | PVDC | 25 | 0.20 | 1.0 | 0.7 | Present | 80 ⇒ 37 |
| Ex. 7 | PVDC | 2 | 0.21 | 12.9 | 9.0 | Present | 80 ⇒ 34 |
| | (cat) | | | | | | |
| Ex. 8 | PVDC | 50 | 0.21 | 0.5 | 0.4 | Present | 80 ⇒ 39 |
| Comp. | PET | 9 | 0.23 | 5.5 | 29 | Absent | 80 ⇒ 42 |
| Ex. 1 | | | | | | | |
| Comp. | ONY | 9 | 0.18 | 1.4 | 270 | Absent | 80 ⇒ 46 |
| Ex. 2 | | | | | | | |
| Comp. | OPP | 9 | 0.24 | 35 | 10 | Absent | 80 ⇒ 40 |
| Ex. 3 | | | | | | | |

### Example 1

### 1. Production of Packaging Material

A chemical conversion treatment solution composed of phosphoric acid, polyacrylic acid (acrylic-based resin), a chromium (III) salt compound, water, and alcohol was applied to both sides of a 40 μm thick aluminum foil (A8021-O) as the metal foil layer 12, and then dried at 180° C. to form a chemical conversion coating. The chromium adhesion amount of this chemical conversion coating was 10 mg/m² per one side.

Next, a 15-μm thick biaxially stretched nylon (ONY-6) film as the substrate layer 11 was dry-laminated (adhered together) to one side (outer surface) of the above-described chemical conversion-treated aluminum foil (metal foil layer 12) via a two-part curing type urethane adhesive (3 μm).

Next, as shown in Table 1, a 9 μm thick PET film was dry-laminated as the heat-resistant gas barrier layer 21 via a two-part curing type urethane-based adhesive (3 μm) on the other side (inner surface) of the aluminum foil after the above dry-lamination.

Next, a two-part curing type urethane-based adhesive (3 μm) as the adhesive layer 4 was gravure-coated on the inner surface of the PET film as the heat-resistant gas barrier layer 21. In this process, the rectangular shaped area where the opening portion is to be formed is not coated with an adhesive, and the rectangular shaped area was left as an uncoated area. An adhesive was applied only to the outer peripheral portion (heat-sealing portion: remaining sealant layer) of the opening portion.

Next, a 40 μm thick CPP film containing a lubricant (e.g., erucamide) as the sealant layer 13 was overlaid on the inner surface of the heat-resistant gas barrier layer 21 on which the above adhesive was coated only in the required areas, and was sandwiched between a rubber nip roll and a laminate roll heated to 100° ° C. and pressed to be dry-laminated. Thus, a laminate constituting the packaging material 1 was procured.

Next, the laminate was rolled onto a roll shaft and aged at 40° C. for 10 days. A CPP film for the sealant layer was cut out of the aged laminate using a laser cutter along the outer peripheral edge portion of the uncoated adhesive portion to form an opening portion 15 in the intermediate portion of the sealant layer 13 to obtain the packaging material sample of Example 1. Note that in this packaging material sample, the heat-resistant gas barrier layer 21 was arranged so that the heat-resistant gas barrier layer 21 is exposed to the inner surface via the opening portion 15.

### 2. Measurement of Water Vapor Transmission Rate

The water vapor transmission rate was measured in accordance with JIS K7129-1 (humidity sensor method, 40° C., 90% Rh) for the resin film for the heat-resistant gas barrier layer 21 used when preparing the packaging material sample of Example 1. The results are also shown in Table 1.

### 3. Measurement of Thermal Conductivity

The thermal conductivity was measured by the steady-state heat flowmeter method (HFM method) for the resin film for the heat-resistant gas barrier layer 21 used when preparing the packaging material sample of Example 1. The results are also shown in Table 1.

### 4. Measurement of H₂S Gas Permeability, Etc., of Resin Film.

The hydrogen sulfide (H₂S) gas permeability was measured in accordance with JIS K7126-1 for the resin film for the heat-resistant gas barrier layer 21 used when preparing the packaging material sample of Example 1. The results are also shown in Table 1.

### 5. Evaluation of Cooling Performance (Cooling Effectiveness)

Two sheets of the packaging material samples of Example 1 with a size of 100 mm×100 mm were prepared. Note that the opening portion 15 in this packaging material sample was square with a size of 60 mm×60 mm.

The two sheets of the packaging material samples were overlaid facing each other with the opening portion 15 facing inward, and the two sheets of the overlaid packaging material samples were heat-sealed at a width of 5 mm at 10 mm from the end portion on three of the four surrounding sides to produce a 3-sided bag.

In a temperature environment at room temperature (25° C.), 80 ml of 80° ° C. hot water was poured into that three-way bag through the opening portion, and a thermometer was further inserted. Thereafter, the opening portion was closed with an eyeball clip, and the temperature change of the hot water was measured over a 3-minute period. The temperature immediately after the hot water pouring and the temperature after 3 minutes in the measurement results are also shown in Table 1.

### Example 2

A sample of Example 2 was prepared in the same manner as in Example 1, except that an ONY-6 film was used as the heat-resistant gas barrier layer 21, and then measurements (evaluations) were performed in the same manner as in Example 1. The results are also shown in Table 1.

### Example 3

A sample of Example 3 was prepared in the same manner as in Example 1, except that an OPP film (biaxially stretched polypropylene film) was used as the heat-resistant gas barrier layer 21, and then measurements (evaluations) were performed in the same manner as in Example 1. The results are also shown in Table 1.

### Example 4

A sample of Example 4 was prepared in the same manner as in Example 1, except that a polyvinylidene chloride (PVDC) film of 10 μm thickness was used as the heat-resistant gas barrier layer 21, and then measurements (evaluations) were performed in the same manner as in Example 1. The results are also shown in Table 1.

### Example 5

A sample of Example 5 was prepared in the same manner as in Example 1, except that a PVDC film of 15 μm thickness was used as the heat-resistant gas barrier layer 21, and then measurements (evaluations) were performed in the same manner as in Example 1. The results are also shown in Table 12.

### Example 6

A sample of Example 6 was prepared in the same manner as in Example 1, except that a PVDC film of 25 μm thickness was used as the heat-resistant gas barrier layer 21, and then measurements (evaluations) were performed in the same manner as in Example 1. The results are also shown in Table 1.

### Example 7

A sample of Example 7 was prepared in the same manner as in Example 1, except that a heat-resistant gas barrier layer 21 was formed by coating the PVDC with a thickness of 2 μm on the other side (inner side) of an aluminum foil for a metal foil layer, and then measurements (evaluations) were performed in the same manner as in Example 1. The results are also shown in Table 1.

### Example 8

A sample of Example 8 was prepared in the same manner as in Example 1, except that a PVDC film of 50 μm thickness was used as the heat-resistant gas barrier layer 21, and then measurements (evaluations) were performed in the same manner as in Example 1. The results are also shown in Table 12.

### Comparative Example 1

A sample of Comparative Example 1 was prepared in the same manner as in Example 1, except that the sealant layer 13 was formed on the entire inner surface side of the heat-resistant gas barrier layer 21, i.e., no opening portions 15 were formed in the sealant layer 13, and the same measurements (evaluation) were made. The results are also shown in Table 1.

### Comparative Example 2

A sample of Example 2 was prepared in the same manner as in Example 1, except that an ONY-6 film was used as the heat-resistant gas barrier layer 21, and then measurements (evaluations) were performed in the same manner as in Comparative Example 1. The results are also shown in Table 1.

### Comparative Example 3

A sample of Example 3 was prepared in the same manner as in Example 1, except that an OPP film was used as the heat-resistant gas barrier layer 21, and then measurements (evaluations) were performed in the same manner as in Comparative Example 1. The results are also shown in Table 1.

### <Overall Review>

As is clear from Table 1, the packaging material samples of Examples 1 to 8 related to the present disclosure had appropriate and high cooling performance (cooling effect), with the temperature after 3 minutes being less than 40° C.

In contrast, the packaging material samples of Comparative Examples 1 to 3, which were out of the gist of the present disclosure, had a temperature of 40° C. or higher after 3 minutes and could not achieve high cooling performance.

### Aspects

It would be understood by those skilled in the art that the exemplary embodiments described above are specific examples of the following aspects.
[1] A packaging material for all-solid-state batteries for encapsulating a solid-state battery body, comprising:
a substrate layer;
a metal foil layer laminated on an inner surface side of the substrate layer;
a sealant layer laminated on an inner surface side of the metal foil layer; and
a heat-resistant gas barrier layer made of resin, the heat-resistant gas barrier layer being provided between the metal foil layer and the sealant layer,
wherein the sealant layer is provided with an opening portion formed in a portion corresponding to the solid-state battery body to be encapsulated, and
wherein the heat-resistant gas barrier layer is exposed on an inner side in the opening portion.

According to the packaging material for all-solid-state batteries as recited in the above-described Item [1], the heat-resistant gas barrier layer is provided between the metal foil layer and the sealant layer, and an opening portion is formed in the sealant layer corresponding to the solid-state battery body in which the heat-resistant gas barrier layer is exposed. Therefore, the heat generated from the solid-state battery body is transferred to the metal foil layer via the heat-resistant gas barrier layer and dissipated without being blocked by the sealant layer, thereby ensuring sufficient cooling property. In this embodiment, the heat-resistant gas barrier layer is placed on the inner surface side of the metal foil layer. Therefore, even if a hydrogen sulfide gas or another gas is generated when the solid electrolyte of the solid-state battery body reacts with moisture in the ambient air, the heat-resistant gas barrier layer can assuredly prevent the leakage of such a gas.
[2] The packaging material for all-solid-state batteries, as recited in the above-described Item [1],
wherein a resin constituting the heat-resistant gas barrier layer has a water vapor transmission rate of 50 (g/m²/day) or less as measured in accordance with JIS K7129-1 (humidity sensor method 40° C. 90% Rh).

According to the packaging material for all-solid-state batteries, as recited in the above-described Item [2], the water vapor transmission rate of the heat-resistant gas barrier layer is specified. Therefore, the infiltration of moisture, such as water vapor gas, from the outside can be prevented by the gas permeation prevention action of the heat-resistant gas barrier layer. Consequently, the generation of a hydrogen sulfide gas itself due to the reaction between the moisture and the solid electrolyte can be suppressed, and leakage of hydrogen sulfide gas, etc., can be prevented more reliably.
[3] The packaging material for all-solid-state batteries, as recited in the above-described Item [1] or [2],
wherein the heat-resistant gas barrier layer is made of a resin having a melting point higher than that of the sealant layer by 10° C. or more.

According to the packaging material for all-solid-state batteries, as recited in the above-described Item [3], the heat-resistant gas barrier layer has a high melting point. Therefore, the melting and leakage of the heat-resistant gas barrier layer can be prevented when thermally bonding the sealant layer, and gas leakage can be prevented even more reliably.
[4] The packaging material for all-solid-state batteries, as recited in any one of the above-described Items [1] to [3],
wherein the resin constituting the heat-resistant gas barrier layer has a thermal conductivity of 0.2 W/m-K or higher.

According to the packaging material for all-solid-state batteries, as recited in the above-described Item [4], the thermal conductivity of the gas barrier layer is specified. Therefore, the cooling property can be further improved.
[5] An all-solid-state battery comprising:
the packaging material for all-solid-state batteries, as recited in any one of the above-described Items [1] to [4]; and
a solid-state battery body encapsulated by the packaging material.

According to the above-described Item [5], it identifies an all-solid-state battery using the packaging material as recited in any one of the above-described Items [1] to [4], and therefore, the same effects as described above can be obtained.
[6] The all-solid-state battery as recited in the above-described Item [5],
wherein the heat-resistant gas barrier layer and the solid-state battery body are in contact with each other.

According to the above-described Item [6], the solid-state battery body can be held in a stable condition.

It should be recognized that the terms and expressions used herein are for illustrative purposes only, are not to be construed as limiting, do not exclude any equivalents of the features shown and described herein, and allow for various variations within the claimed scope of this invention. It should be recognized that the invention does not exclude any equivalents of the features shown and described herein, but permits various variations within the claimed scope.

### INDUSTRIAL AVAILABILITY

The packaging material for all-solid-state batteries of this disclosure can be suitably used as a material for a casing to accommodate a solid-state battery body.

### DESCRIPTION OF REFERENCE SYMBOLS

1: Packaging material
11: Substrate layer
12: Metal foil layer
13: Sealant layer
15: Opening portion
21: Heat-resistant gas barrier layer
5: All-solid-state battery body

1. A packaging material for all-solid-state batteries for encapsulating a solid-state battery body, comprising:
a substrate layer;
a metal foil layer laminated on an inner surface side of the substrate layer;
a sealant layer laminated on an inner surface side of the metal foil layer; and
a heat-resistant gas barrier layer made of resin, the heat-resistant gas barrier layer being provided between the metal foil layer and the sealant layer,
wherein the sealant layer is provided with an opening portion formed in a portion corresponding to the solid-state battery body to be encapsulated, and
wherein the heat-resistant gas barrier layer is exposed on an inner side in the opening portion.

2. The packaging material for all-solid-state batteries, as recited in claim 1,
wherein a resin constituting the heat-resistant gas barrier layer has a water vapor transmission rate of 50 (g/m²/day) or less, as measured in accordance with JIS K7129-1 (humidity sensor method 40° C. 90% Rh).

3. The packaging material for all-solid-state batteries, as recited in claim 1,
wherein the heat-resistant gas barrier layer is made of a resin having a melting point higher than that of the sealant layer by 10° C. or more.

4. The packaging material for all-solid-state batteries, as recited in claim 1,
wherein the resin constituting the heat-resistant gas barrier layer has a thermal conductivity of 0.2 W/m-K or higher.

5. An all-solid-state battery comprising:
the packaging material for all-solid-state batteries, as recited in claim 1; and
a solid-state battery body encapsulated by the packaging material.

6. The all-solid-state battery as recited in claim 5,
wherein the heat-resistant gas barrier layer and the solid-state battery body are in contact with each other.
